(19) United States
(12) Patent Application Publication
(10) Pub. No.: US 2013/0213809 A1
(43) Pub. Date: Aug. 22, 2013

(54) MEASURING SYSTEM AND METHOD FOR AUTONOMOUS MEASUREMENT OF AN ION CONCENTRATION WITH MICROCHIP CAPILLARY ELECTROPHORESIS

(71) Applicants: Gerardus Antonius Johannes Besselink, Apeldoorn (NL); Harm Rouwhorst, Haulerwijk (NL)

(72) Inventors: Gerardus Antonius Johannes Besselink, Apeldoorn (NL); Harm Rouwhorst, Haulerwijk (NL)

(73) Assignee: CAPILIX B.V., CJ Leeuwarden (NL)

(21) Appl. No.: 13/823,964

(22) PCT Filed: Sep. 27, 2011
(86) PCT No.: PCT/NL11/50652

§ 371 Date: Apr. 26, 2013

(30) Foreign Application Priority Data
Sep. 27, 2010 (NL) 1038266

(51) Int. Cl. G01N 27/447

(52) U.S. Cl. CPC G01N 27/44791
USPC 204/451; 204/601

(57) ABSTRACT

A measuring system and method are disclosed for measuring an ion concentration in a process liquid using capillary electrophoresis. In at least one embodiment, the measuring system includes an inlet connectable to a process for supplying the process liquid; a throughflow system connected to the inlet; a capillary electrophoresis measuring device connected to the throughflow system and provided with a detector and measuring capillary; and a data processing unit connected operatively during use to the capillary electrophoresis measuring device.

The invention relates to a measuring system for measuring one or more ion concentrations in a process liquid on the basis of microchip capillary electrophoresis.

Such process liquids relate to, among others, water treatment, drinking-water production, (glass) horticulture and industrial process flows.

Capillary electrophoresis, also referred to as CE, is an analytical separation technique. Use is made here of an electric field which is applied over a conduit, channel, tube or capillary such that a sample flowing through the capillary will be separated. This separation is caused by the differences in the electrophoretic mobility of particles from the sample. Influencing this are, among other factors, the charge and the dimensions of the particle.

Conventional measuring systems comprise a capillary whose two outer ends, between which a detector is placed, are situated in two buffer solutions. A common difference in direct voltage between the two buffer vessels amounts to 15-50 kV. By placing one outer end of the capillary in a sample solution for a short time, a small quantity of the sample will be drawn into the capillary.

As a consequence of differences in the electrophoretic mobility of charged particles in the sample these particles move with a different speed as a result of the applied voltage. In short, a separation of the charged particles takes place on the basis of their electrophoretic mobility. They hereby pass the detector at different moments in time. In these systems use can be made of diverse types of detector, including ultraviolet or fluorescence.

Many existing laboratory systems make use of electrophoresis in a relatively small capillary such that the capillary can be embodied as microfluidic chips. Use can hereby be made of relatively small sample volumes in the order of magnitude of nanolitres to microlitres. Such measuring systems are usually used for analysis of DNA fragments and other types of biomolecule. These systems usually make use of syringes for supplying the sample.

A problem with known measuring systems making use of capillary electrophoresis, and in particular microchip capillary electrophoresis, is that they are not suitable for performing measurements for the purpose of monitoring and cannot actually be used inline or at-line in an industrial process environment.

An object of the invention is to obviate and solve the above stated problems as far as possible in order to achieve a robust measurement of concentration(s) of ions and/or possible other substances dissolved in a process liquid.

This object is achieved with a measuring system according to the invention for measuring an ion concentration in a process liquid using microchip capillary electrophoresis, the measuring system comprising:
an inlet connectable to a process for supplying the process liquid;
a throughflow system connected to the inlet;
a capillary electrophoresis measuring device connected to the throughflow system and provided with a detector and measuring capillary; and
a data processing unit connected operatively during use to the capillary electrophoresis measuring device.

By connecting the inlet system to an (industrial) process a quantity of process liquid can be carried in automatic manner to a measuring system and analysed for the purpose of determining the concentration of one or more ion types and/or other dissolved substances. Providing a throughflow system achieves that the sample taken from the process liquid is carried in correct manner along the detector. Use is preferably made here of a microchip, so that it is possible to refer to microchip capillary electrophoresis.

In order to make a measuring system autonomously operating and sufficiently robust, a way must be found to successfully link the large macrofluidic world of the process plants with the correspondingly large volumes and flow rates on the one hand and the microfluidic world of very small conduits with microlitre and nanolitre volumes on the other. One of the factors which must be considered is that the pressure balance in the microchip can be very easily disrupted, and that pressure-controlled flow often has a dominant effect compared to electro-kinetically controlled flow. These latter factors will have an adverse effect on the robustness and reproducibility of such an automated measurement. For this purpose a measuring system according to the invention is provided with a throughflow system. A controlled pressure-driven/controlled flushing, throughflow and filling of the microchip with samples and other liquids is hereby alternated with an electro-kinetically controlled microchip manipulation.

The throughflow system is preferably provided here with a valve for admitting a process liquid, wherein a filter is applied for a first filtering. The throughflow system is further provided with a number of reservoirs with for instance reagents and optional chemical additives, among other purposes for adding reagent and, if desired, diluting a taken sample.

The throughflow system is preferably also provided with an automated system in the form of switching means for switching the valves in the system. A sample can hereby be taken from an (industrial) process in automatic manner. A relevant part of the system is preferably first flushed here with a process liquid, after which the final sample is taken. After optionally being improved, this sample is then carried to the capillary of the measuring system for analysis of the sample. This transport of the sample from the buffer to the capillary takes place by optionally diluting the sample, for instance with reagent, milliQ or buffer.

The switching means are preferably also adapted to flush the measuring system from a flushing reservoir or buffer reservoir and also to provide additives to the measuring device. Through use of the throughflow system it is possible to take a sample in automated manner. It is hereby possible to take and analyse a sample online or optionally at-line, and preferably for monitoring purposes, and to subsequently process the measurement data in a processing unit. Such a data processing unit can preferably be used for the purpose of using the analysed measurement data to modify process settings, optionally in fully automatic manner. The measuring system according to the present invention in this way becomes part of a control system for the (industrial) process. Control and monitoring of such processes is hereby improved in significant manner. These processes relate particularly to water processes in environments such as drinking-water production and water treatment plants, food industry, paper industry and glass horticulture. Other processes can however also be envisaged.

In an advantageous preferred embodiment according to the present invention the throughflow system is provided with a sample improvement module.

By providing a sample improvement module the composition of the measurement sample finally obtained from the process flow can be modified to the dynamic measurement range of the microchip conductivity detector, this for instance by means of dilution with buffer or by means of adding reagent. Such a modification to the dynamic measurement range may be required particularly in the case of a more concentrated sample or a type of sample with a richer background composition. Such a sample improvement module is preferably integrated into the throughflow system and therefore makes use of the valves and/or reservoirs provided therein. In a number of cases use can be made of an optimized and fixed operational setting of such a sample improvement module.

The sample improvement module is preferably connected operatively to an internal controller of the measuring system for the purpose of adjusting settings of the module. It is particularly recommended to operatively connect the sample improvement module to an internal controller when there is a widely varying composition of the sample water. Use is for instance made for this purpose of a first sample which is presented substantially unprocessed to a detector in or at the throughflow for a first analysis thereof. Ensuing from this first analysis is for instance a first indication of the ion concentrations to be measured/anticipated in the sample. Use can for instance be made here of a total conductivity measurement, pH measurement or measurement of determined so-called control ions using an ion-specific electrode or light absorption (spectrum) determination, depending on the most important control parameter. On the basis of the first analysis it can then be determined with the internal controller what the desired settings are, for instance for the amount of dilution or reagent which has to be supplied to bring the measurement of the ion concentrations into the optimum range of the detector. Alternatively or additionally, the so-called plug length or sample length in the capillary can also be adjusted via the first measurement with the internal controller. The measuring system according to the invention is in this way suitable to cope with inter alia wide variations in the process flow for measuring, wherein possible corrections or adjustments to settings or parameters can be performed in automated manner and online. A measuring system is hereby realized which can actually be placed in an industrial process environment without continuous or semi-continuous monitoring or supervision by an operator.

An advantageous embodiment of the measuring system comprises a conductivity meter. This conductivity meter particularly forms part of an internal controller of the sample improvement module. The settings for realizing a sample for measuring by means of the capillary electrophoresis measuring system according to the invention are preferably wholly or partially based on the conductivity of the sample measured using this conductivity meter. For this purpose the conductivity of a crude sample is preferably measured. A reliable measurement is obtained by for instance diluting the sample to be actually measured such that the sample to be measured has a conductivity in an optimum measurement range.

The optimum measurement range is preferably determined such that there is a substantially linear relation within this range. This increases the measurement accuracy. An additional advantage is that calibration of the measurement is simpler in that it is possible to suffice with an automated, so-called one-point calibration. The calibration hereby becomes simpler and quicker without loss of accuracy. Alternatively or additionally, the sample to be measured can also be preprocessed in other manner. The plug length for instance can thus be varied. It is also possible to modify the voltage in the measuring system and control it on the basis of microflows measured in the different channel parts of the microchip.

In an advantageous preferred embodiment according to the present invention the measuring system is provided with a voltage source, wherein the voltage source is suitable for applying 2 kV-10 kV, and preferably about 8 kV, over the capillary.

Providing a voltage source in said ranges makes it possible to provide the capillary, which is for instance suitable for so-called microfluids, with a relatively high direct voltage so as to thereby increase the electrophoretic migration speed of the ions in a sample and as it were draw the different ions apart. The accuracy of the measurement is hereby increased since the different types of ion are carried in better separated manner along the detector. The time duration of the measurement is hereby also shortened considerably. It is for instance possible in automatic manner and within a time frame of two minutes to take a sample from a process liquid, measure and analyse it and have data available for instance for processing by the automatic control system of the process. The specific times depend of course on various conditions, such as the size of the measuring system and the conduits therein.

In a further advantageous preferred embodiment according to the present invention the throughflow system is provided with a bypass for bypassing the capillary and the microchip.

Providing a bypass, particularly for the capillary, makes it possible to flush the whole system without the microchip also having to be flushed. The valves for instance in the throughflow system can hereby be thoroughly cleaned. With the bypass it is possible, if desired, to exclude the capillary and the detector from this flushing.

An insulating liquid is preferably provided during use of the measuring system, preferably demineralized water, MilliQ or other liquid which does not conduct electricity very well, supplied from a reservoir such that at least some of the valves are substantially insulated from an applied voltage during the capillary electrophoresis measurement. Such an insulating, or at least poorly conductive, effect is desirable in preferably all embodiments of a measuring system according to the invention, although the use of the bypass as described above is extra-advantageous here. The valves providing access to the capillary are preferably insulated from the applied voltage during the measurement, since the operational safety and the reliability and accuracy of the measurement could hereby be affected. This is realized by making use of insulating liquid, preferably demineralized water arranged between/in the valve and preferably the bypass. The use of this non-conductive liquid in the valves, and preferably the bypass, brings about an insulation between the chip over which the direct voltage is applied and substantially the rest of the measuring system.

Particularly the feed conduits to the measuring device are preferably provided with the insulating liquid during a measurement. The feed side is hereby insulated. Owing to this insulation there is no further electrical connection between the feed channels outside the measuring device and/or between the feed channels and the CE chip, this particularly relating to the electrical connection in the microchannels in the CE chip itself. During a measurement the electrical voltages are then applied to the chip channels, of which there are usually four. These applied voltages cause ion flows in the CE chip. Owing to the insulation that has been realized, these flows will be limited to the CE chip and not leak via the connecting conduits. This makes the measurement more reliable. This is particularly relevant when relatively short conduit lengths are used, whereby insulating values are smaller and the chance of disturbances occurring is greater. The insulation according to the invention prevents this.

In a currently preferred embodiment the discharge side is provided with drippers which discharge the liquid. An air gap is therefore present at this position which provides for the desired insulation. If a choice is made for another configuration of the system according to the invention, an insulation with insulating liquid may also be desirable on the discharge side.

It has been found that the robustness of the measurement and the accuracy thereof are hereby greatly improved. The measuring system according to the invention is hereby made further suitable for measurement in the (industrial) process environment. This is found to be particularly advantageous when the relatively high direct voltages are used over the relatively short length of the capillary.

The capillary preferably has a length in the range of 2 to 20 centimetres and preferably about 5 centimetres. It has been found that a length of the capillary of particularly about 5 centimetres is on the one hand great enough to draw apart the different ion types of the sample to sufficient extent and on the other is small enough to realize a rapid measurement suitable for including in a process control system. It has been found here that the use of the relatively high direct voltage as described above in relation to the relatively short length of the capillary combines accuracy and speed to achieve the desired situation for the purpose of making the measuring system suitable for incorporation in the overall control system for the whole process. Use is preferably made here of capillary dimensions such as channel depth in the order of magnitude of 10 to 25 μm and channel width in the order of magnitude of 40 to 120 μm.

Use is preferably made of the detector, preferably a contactless conductivity detector which is not in direct contact with a process liquid and which measures over a detector width of about 25-750 μm, and preferably about 50-500 μm. It has been found particularly that a detector range of about 250 μm, preferably in combination with the above stated dimensions for the capillary and with the employed voltages, results in a sufficiently rapid and robust/reliable measurement of the sample.

It has been found that a measuring system with the above stated settings and dimensions can perform a complete cycle of taking a sample, analysing the sample, processing and transmitting the data to for instance the control system within a time range of for instance less than 2 to 3 minutes to within even 60 seconds, while conventional measuring systems require five to ten minutes for this purpose.

In a further advantageous preferred embodiment according to the present invention the measuring system is provided with more than one chip, wherein each chip is provided with a separate measuring capillary.

By preferably providing the measuring system in modular manner it is possible to place more than one chip in such a measuring system. Because each chip is provided with a separate measuring capillary, is possible to make the measuring system suitable for measuring different types of ion concentration. It is thus possible for instance to make a first chip suitable for measuring for instance anions and to specially adapt a second chip for measurement of cations. By providing, in this embodiment, two separate chips different ion types can be measured with the desired speed and accuracy without the whole measuring system having to be reset for the other ion type. Alternatively or additionally, the measurement speed can be greatly increased through the use of a greater number of separate chips.

The throughflow system is preferably provided such that it is suitable for throughflow of a taken sample to the measuring capillary on each separate chip. In a currently preferred embodiment the throughflow system takes as it were a dual form here so that this throughflow system can also be adapted to the desired types of ion to be measured.

The invention further relates to a method for online measurement of an ion concentration in a process liquid, comprising the steps of:
drawing off a quantity of process liquid;
preparing a measuring system as described above;
preprocessing and transporting a sample from the process liquid to a measuring capillary;
measuring the sample in the measuring capillary with a detector; and
processing the measurement data.

The same effects and advantages apply for the method as for the measuring system. One or more ion concentrations in one or more process liquids can hereby be measured. The method particularly comprises the additional step of transmitting the processed measurement data to a control system for the process. The measurement is in this way integrated into the process control. A step is particularly also provided for automatically processing or improving a sample from the quantity of process liquid that is drawn off. The method has been found extremely suitable for online or at-line measurement of an (industrial) process liquid wherein a direct voltage is provided over the capillary in the range of about 2-10 kV, and preferably about 8 kV. This employed direct voltage is preferably applied in combination with inter alia the dimension of the capillary as described above. The measuring capillary is preferably a capillary electrophoresis microchip.

Further advantages, features and details of the invention will be elucidated on the basis of the preferred embodiments thereof, wherein reference is made to the accompanying drawings, in which:

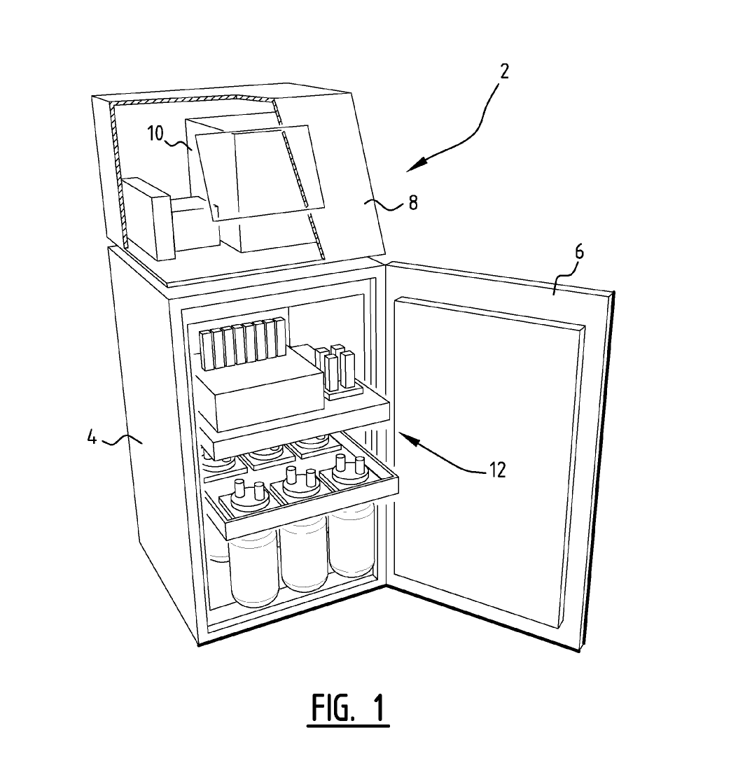

FIG. 1 shows a view of the measuring system according to the invention;

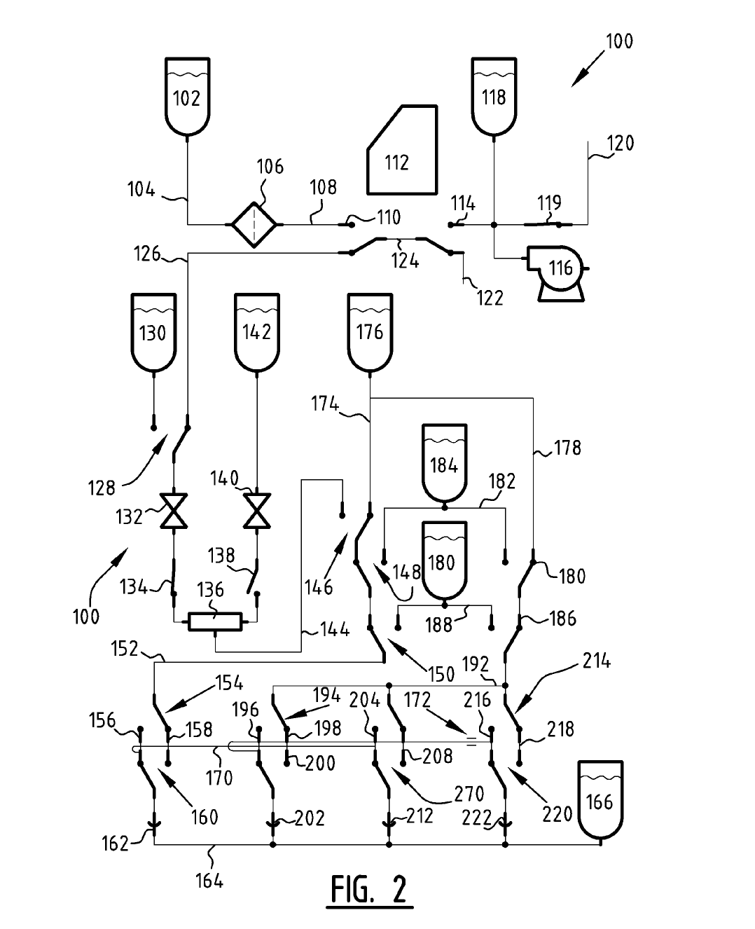

FIG. 2 shows a schematic diagram of the measuring system of FIG. 1;

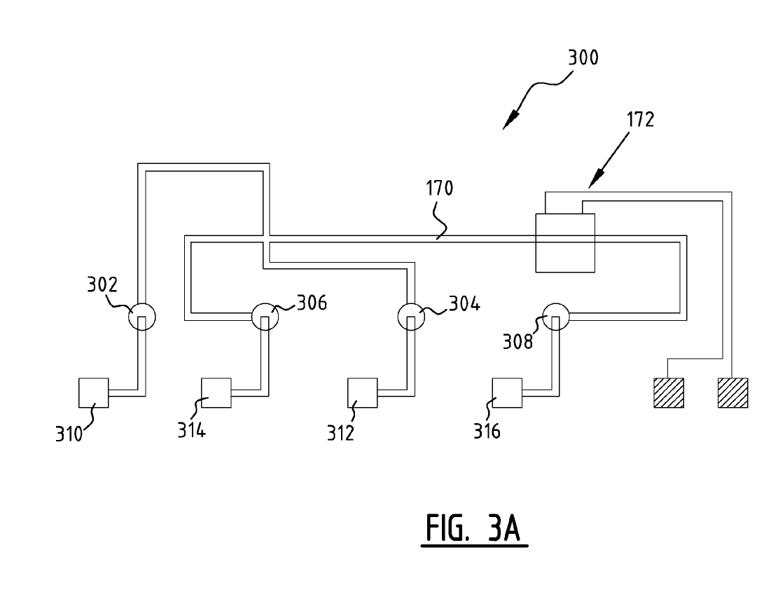

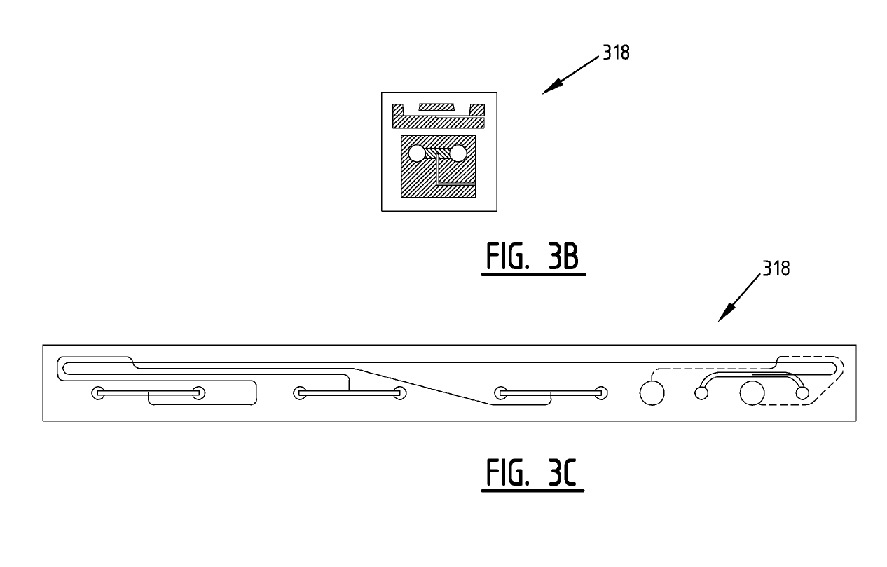

FIGS. 3A-C show a schematic representation of a microchip as can be used in the measuring system of FIG. 1;

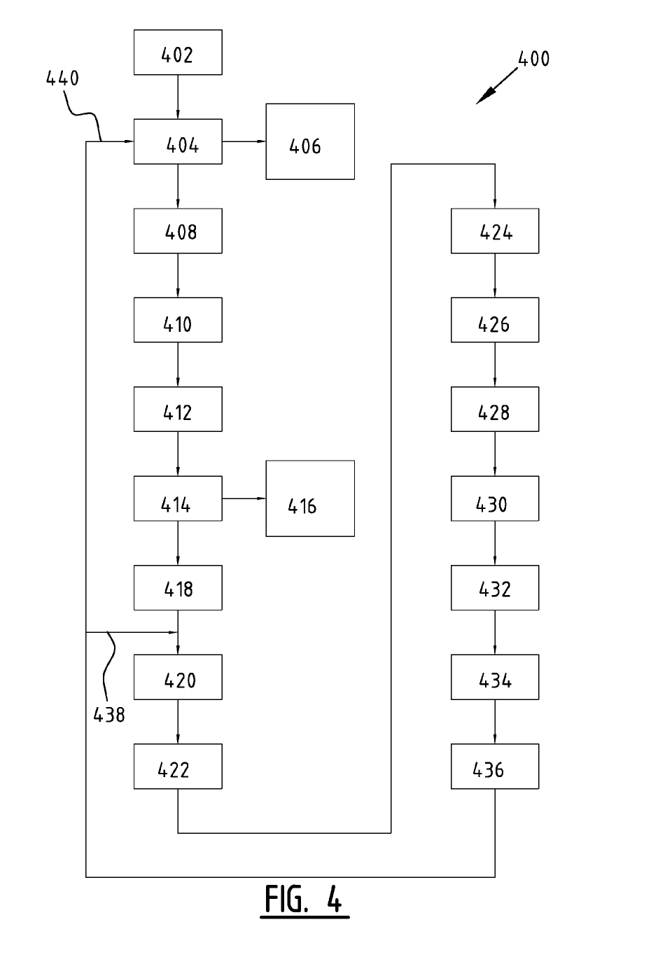

FIG. 4 shows a schematic representation of the operation of the measuring system of FIG. 1;

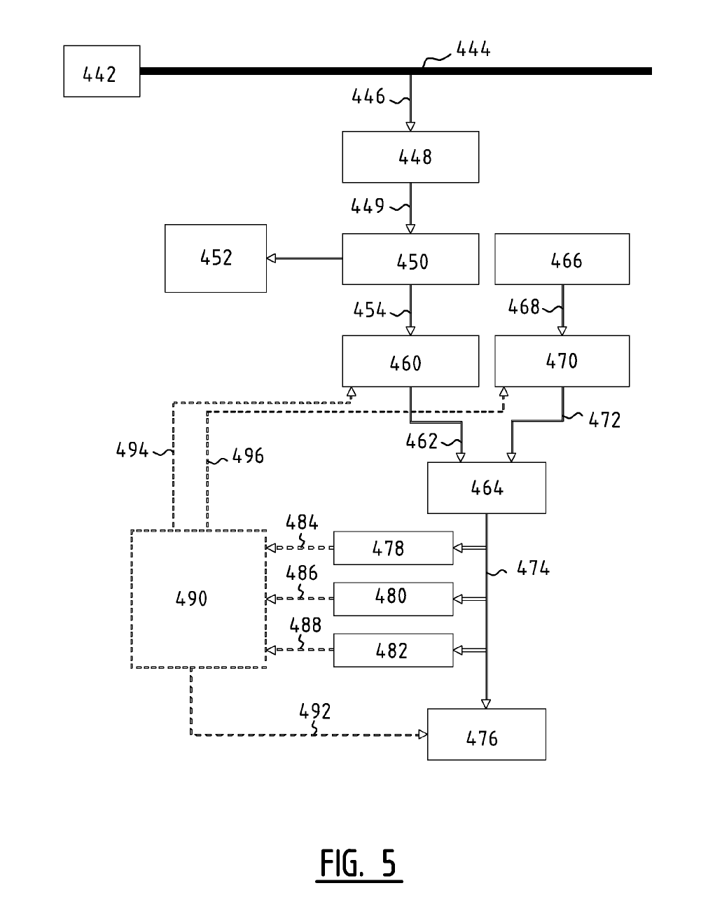

FIG. 5 shows a schematic representation of the sample improvement module of the measuring system of FIG. 1;

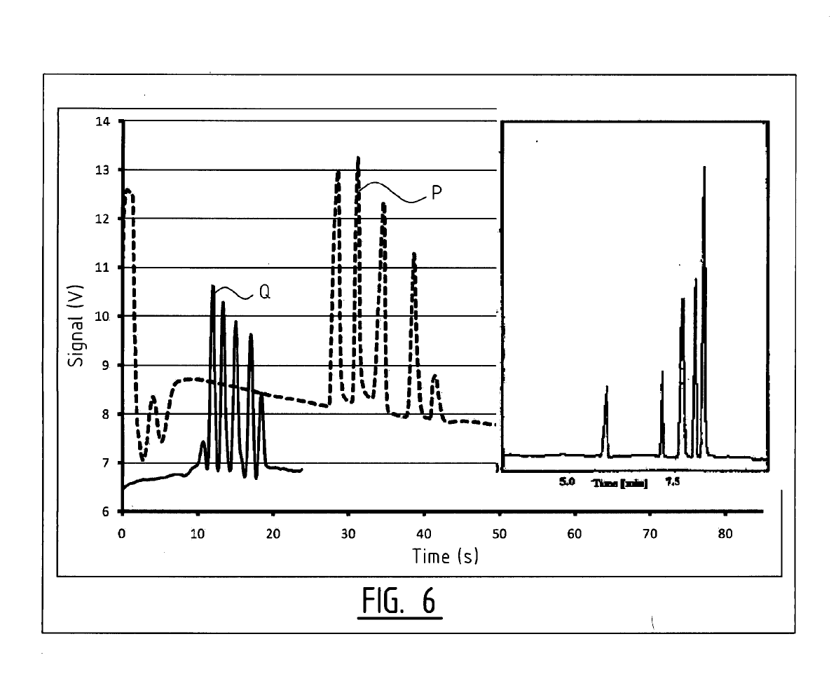

FIG. 6 shows measurement results with a comparison of the measuring system of FIG. 1 to a conventional system;

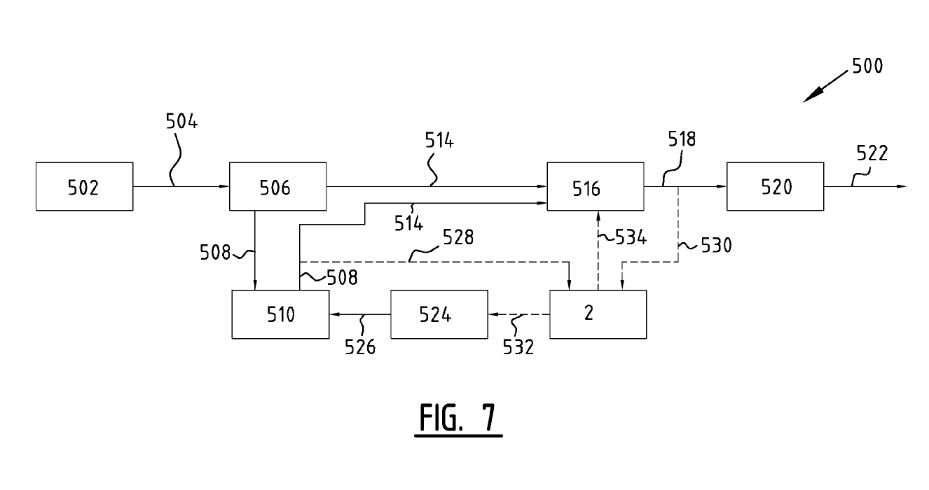

FIG. 7 shows a schematic representation of an application of the measuring system of FIG. 1 in an industrial process;

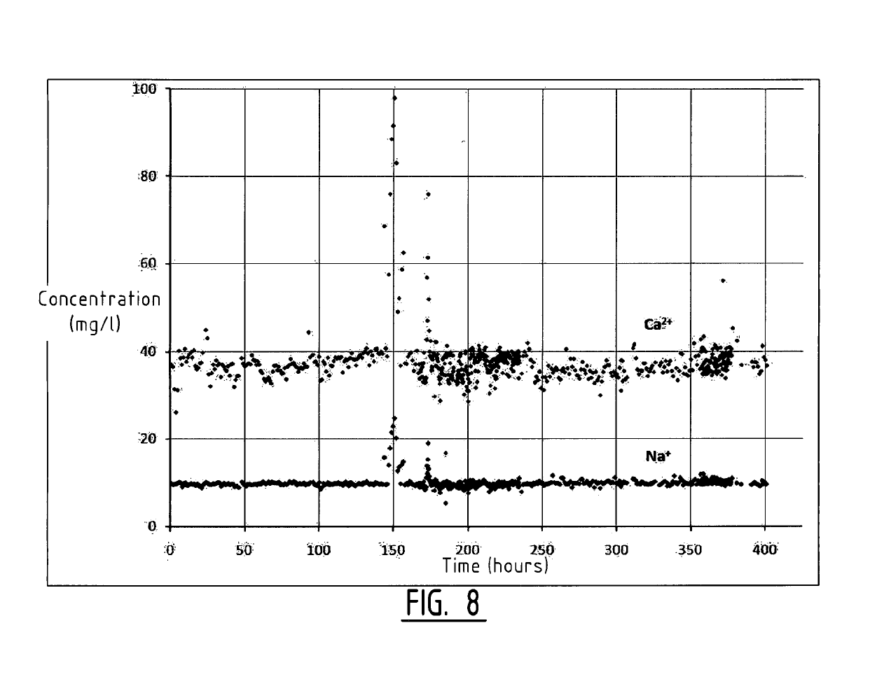

FIG. 8 shows measurement results using the system of FIG. 7;

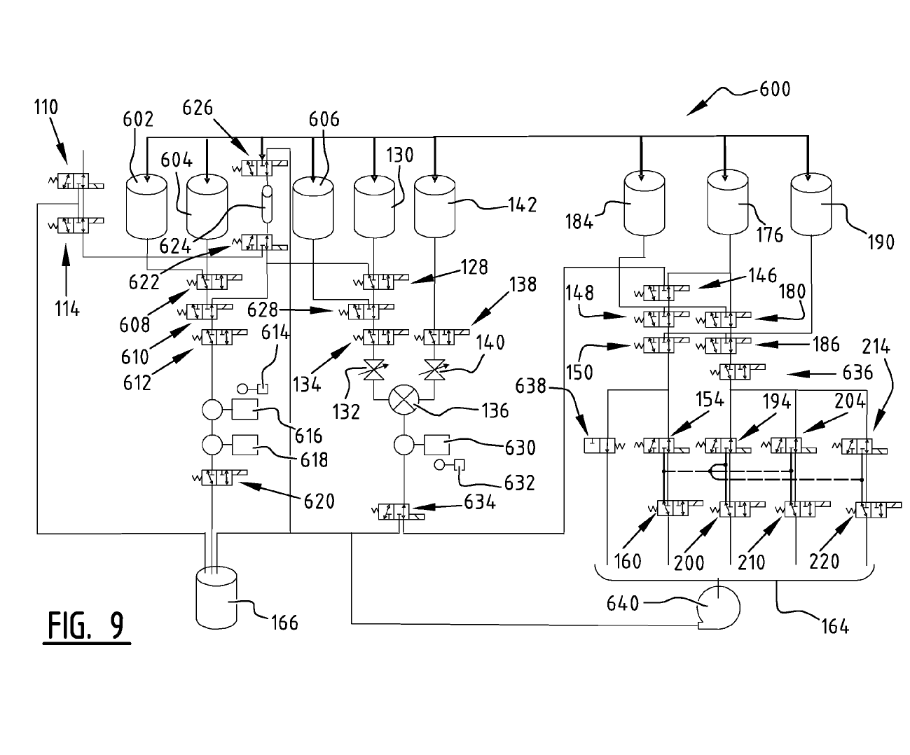

FIG. 9 shows a diagram of an alternative measuring system;

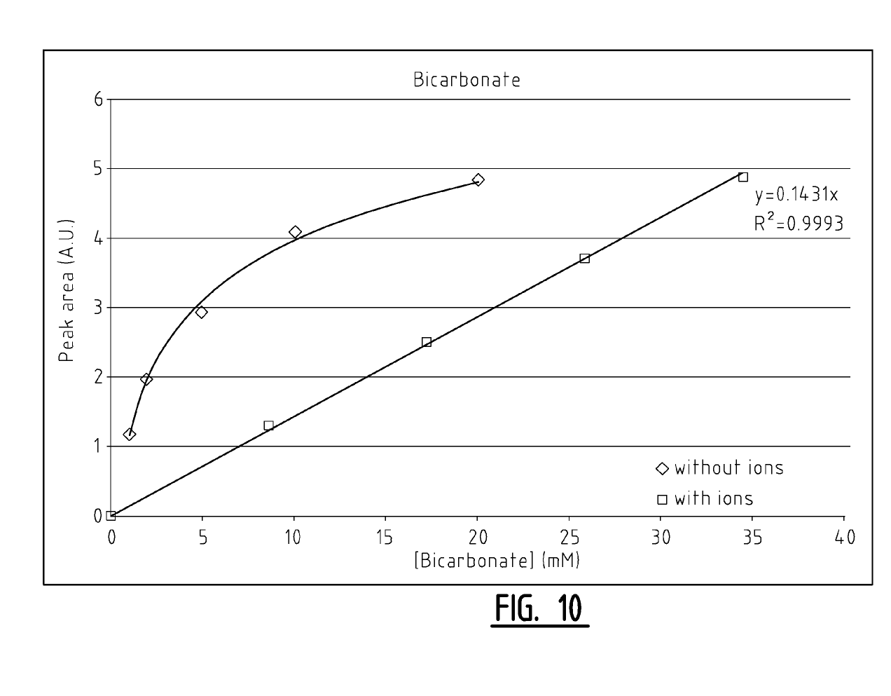

FIG. 10 shows measurement results; and

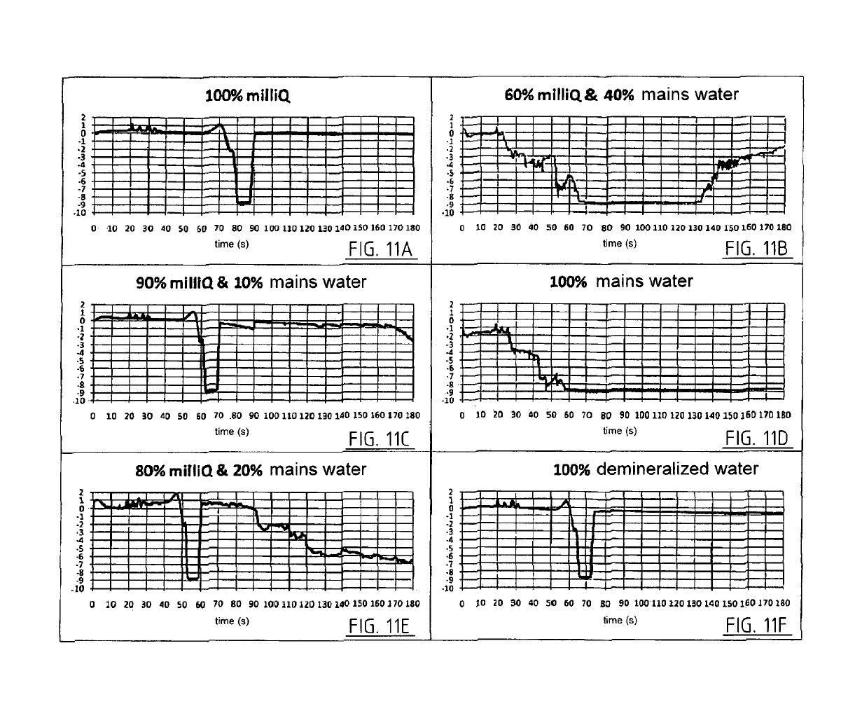

FIGS. 11A-F show measurement results.

A measuring system 2 (FIG. 1) is provided with a housing 4 with a door 6 on the front side. Provided on the top side is an upper part 8 with a power supply unit, measuring unit, data processing unit and monitor or screen 10. Provided in the interior of housing 4 are a number of drawers 12 in which the technical installation is accommodated. This includes a number of liquid reservoirs, valves, a chip and the whole throughflow system with said valves.

Measuring system 2 is shown schematically in a possible embodiment via diagram 100. A quantity of process liquid is carried from a bioreactor 102 using conduit 104 through filter 106 and subsequently via conduit 108 to valve 110. Also provided in diagram 100 is a safety switch 112. The process liquid is then discharged via valve 114 to waste reservoir 122. A compressor 116 supplies compressed air 118 which, for safety reasons, is connected via valve 119 to an air discharge 120. An application with a liquid pump is also possible for bringing about flow of liquid in the conduits and microchip channels. At the start of taking a sample from bioreactor 102 the process liquid flows to discharge 122 in order to as it were flush conduit 124 clean and store a quantity of process liquid therein. In a currently preferred embodiment the length of this conduit 124 is about 1.25 m and contains therein a supply volume of sample. In an alternative embodiment a reservoir can be provided for this purpose. A quantity of process liquid is hereby introduced in automatic manner into measuring system 2.

By switching valves 110, 114 the process liquid can, through driving of the process liquid with the compressed air in conduit 124, be carried via conduit 126, valve 128, restriction 132 and valve 134 to mixer 136. Valve 128 here enables measuring system 2 to use calibration liquid from calibration reservoir 130. Mixer 136 mixes the process liquid from conduit 124 with reagent or diluting liquid coming from reagent reservoir 142 via valve 138 and restriction 140. The hereby produced sample is carried via conduit 144 to valve 146. From valve 146 the sample can flow via valves 148 and 150 via conduit 152 to entry valve 154. From entry valve 154 access is gained to reservoir part 156. Reservoir part 156 is situated in the microchip. Via valve 160 and passage 162 the surplus sample part is carried via conduit 164 to outlet 166. The sample part used for the measurement is carried via capillary 170 to detector 172. This will be further elucidated below in this application. In the shown embodiment detector 172 is a contactless conductivity meter.

The sample is in this way carried from conduit 124 to detector 172 for the purpose of performing the desired measurement. For the purpose of the measurement a direct voltage is applied over capillary 170 using a voltage source (not shown).

Valve 146 can be provided via conduit 174 with milliQ, or demineralized water, from milliQ buffer 176. Using the milliQ an insulating effect is produced on the valves, including particularly valves 154 and 160. As soon as the sample part for the measurement has been loaded into reservoir part 156, the milliQ is placed in bypass 158 such that the throughflow parts of valves 154 and 160 and relevant feed conduits are filled with milliQ. In respect of the limited volume of capillary 170 and the relatively large switching volume of the valves, including valves 154, 160, and the relatively high direct voltage employed, the insulating effect of the milliQ is relevant for the purpose of obtaining a reliable measurement. The milliQ can be carried further via conduits 178 and valve 180. Provided at valves 148 and 180 in the shown embodiment is conduit 182 with which a buffer liquid from reservoir 184 can be supplied to the primary part, the part in which the sample and reservoir part 156 are located, and the secondary part, the part which can be reached via valve 186. Situated between valves 150 and 186 is conduit 188 with which a NaOH solution from reservoir 190 can be supplied to the primary part and subsequently to the second part. The supply to the secondary part flows from valve 186 via conduit 192 to valve 194, secondary capillary part 196 or optionally via bypass 198, valve 200, discharge 202 to outlet 166. This hereby forms a second channel in addition to the first sample channel. Also provided in similar manner to the second channel are a third and fourth channel respectively with valves 204, capillary part 206, bypass part 208, valve 210 and discharge 212, and with valve 214, capillary part 216, bypass part 218, valve 220 and discharge 222.

In an alternative embodiment (not shown) it is possible to provide an additional valve after valve 186 for the purpose of blocking the feed to valves 194, 204 and 214. It is in this way possible to dispense with air valve 119 and to also no longer require switch-off of compressor 116.

In a possible embodiment microchip 300 (FIG. 3A) comprises a network of microfluidic channels with primary part 156 and secondary parts 196, 206 and 216, with measuring capillary 170 where detector 172 is provided. In the shown embodiment detector 172 is a conductivity meter which, as a result of the ion types being separated, will measure differences in conductivity at the position of detector 172. The sample channel is formed between reservoirs 302 and 304 and a so-called separating channel is formed between reservoirs 306 and 308. Reservoirs 302, 304, 306 and 308 are electrically connected to contacts 310, 312, 314 and 316 respectively. It is hereby possible to apply direct voltages over the different parts of the microfluidic network and thereby generate electric fields in the liquids. The liquid flows in the microfluidic channels and the electrophoretic movement of the ions depend on the direction and magnitude of these electric fields. For this purpose two or three voltage regimes are applied immediately one after another to reservoirs 302, 304, 306 and 308, whereby in a first step the sample channel is filled with sample followed by injection of a determined quantity of sample into the separating channel, followed by separation of the different components and transport along the detector at the end of the separating channel. The shown configuration of microchip 300 is one of the possible embodiments which can be used in measuring system 2. Alternative configurations, for instance configuration 318 (FIGS. 3B and C), are also possible.

Measurement process 400 (FIG. 4) begins with startup step 402 of the installation. After performing a self-test 404 and optionally generating an alarm 406, the system is cleaned in cleaning step 408. After the cleaning step 408 a calibration step 410 is performed, after which calculation of the so-called peak area is performed in step 412. Criteria are then compared to the norm in step 414, after which an alarm is optionally generated in step 416. The calibration is subsequently modified where necessary in modifying step 418. The actual measurement then begins by taking a quantity of process liquid in step 402, including the filtering. The sample is then prepared in preparation step 422, after which the sample is measured in measuring step 424. The peak areas are then calculated in calculation step 426 and the concentrations calculated in calculation step 428. After the comparison in comparing step 430, the data are outputted in data output step 432. Data are stored in a memory in storage step 434, after which the installation goes into the standby position 436. A new sample can then be taken, after which the process is performed once again from step 420. If desired, it is also possible to begin with the self-test in step 404. It has been found in practice that at least ten successive measurements can be performed in cycle 438 without a self-test via cycle 440 being required in step 404. This does however depend on the type of process liquid in which the measuring process 400 is being carried out.

In order to obtain and analyse a sample, process liquid is supplied from an inlet 446 connected to the process 442, and in particular conduit 444 thereof (FIG. 5), and subsequently filtered with filter 448. In the shown embodiment a <0.2 μm filter is used here. A determined quantity of filtered process liquid is then admitted via conduit 449 to the sample loop 450. Surplus sample is discharged via discharge 452. In the first instance the liquid is guided further in unprocessed state via conduit 454 along a detector for the purpose of measuring for instance conductivity 478, measuring the pH 480 and/or measuring a determined type of ion using an ion-selective electrode (ISE) 482. On the basis of the first measurement 484, 486, 488 of untreated filtered process water, a calculation is made in internal controller 490 as to what extent dilution or addition of reagent has to take place from reservoir 466 with feed conduit 468 to dosing module 470, and dosing modules 460 and 470 are controlled accordingly via the internal controller via signals 494 and 496. From modules 460 and 470 the sample is moved on via conduits 462, 472, mixer 464 and conduit 474 to the CE meter 476 and/or the other meters 478, 480, 482. Another option is to adapt the electro-kinetic flow regime in the microchip on the basis of the first measurement for the purpose of modifying via signal 492 the quantity of sample to be injected into the separating channel to meter 476.

### Experiment 1

Measuring system 2 is tested in comparison to conventional systems in respect of speed. Use is made here of the described measuring system 2. The results are shown (FIG. 6) wherein the conductivity (V) is measured through time in seconds (y-axis) and minutes (x-axis) for respectively the measuring system 2 according to the invention and the conventional system. The conventional system is shown in the small graph and shows a time-scale of minutes, even from 5 to 10 minutes, for performing the whole measurement. Measuring system 2 shows a measurement time of about 10-20 seconds, where use is made of 6 kV (graph Q), and about 30-45 seconds for a similar measurement at 2 kV (graph P). This illustrates the possibility of applying system 2 in a monitoring, online/at-line situation.

### Experiment 2

Measuring system 2 is applied in a process 500 for the production of drinking-water (FIG. 7). Water is collected here via a water production plant 502. The collected water is then transported via conduit 504 to a pretreatment system 506. The liquid flow is carried wholly or partially from this pretreatment system 506 via conduit 508 to softening reactor 510. Following softening the water is carried via conduit 512, optionally via pretreatment system 506, via conduit 514 to filter or filtration step 516. Following step 516 the liquid flow is carried via conduit 518 to after-treatment system 520, after which a drinking-water flow 522 is realized. In the shown embodiment measuring system 2 is used to control/regulate the dosing system 524 with which the dosage flow 526 to softening reactor 510 is determined. For this purpose a sample 528 is taken from conduit 512 and/or a sample 530 is taken from conduit 518. Following analysis with measuring system 2, settings 532 of dosing system 524 are modified where necessary. It is also possible to modify settings 534 in step 516 as a result of analysis of sample 530 from conduit 518. The schematically shown application of measuring system 2 in process 500 demonstrates that measuring system 2 according to the invention can be applied in an industrial environment.

Measuring system 2 has been tested in practice at a waterworks wherein process water coming from a softening process was measured continuously for the concentrations of Ca²⁺ and Na⁺ ions. The results shown in FIG. 8 illustrate the levels (concentrations in mg/l) of measured calcium and sodium ions for a period of 400 hours. The levels measured are found to correspond well to reference values included in the same experiment and as determined with standard laboratory methods. These results hereby illustrate the utility of system 2 for use in an online/at-line situation in the industrial practice.

An alternative measuring system 600 (FIG. 9) largely comprises the components of measuring system 100, which are therefore also designated with the same references. The new parts are shown in boxes and will be elucidated below.

Calibration reservoir 672 with high pH reference liquid and calibration reservoir 604 with low pH reference liquid and calibration reservoir 676 with a determined conductivity reference liquid are provided on a drawer 12. Flushing from the process can take place directly from the drain conduit to discharge 166 in order to prevent flushing having to take place unnecessarily via the measuring system. Just as the crude sample which has to be pre-measured, reservoirs 602, 604 are operatively connected via valves 608, 610, 612 to detectors or sensors such as temperature sensor 614, pH meter 616 and pH reference electrode 618. The measured crude sample and calibration liquid are discharged via valve 620. The crude sample can be carried into buffer 624 via valve 622. From buffer 624 the crude sample can be discharged via valve 626 or be carried via valve 622 to the sample improvement at valve 128. In system 600 a valve 628 for calibration liquid from reservoir 606 is added after valve 128. After mixer 136 the improved sample is, if desired, measured with conductivity meter 630 and temperature sensor 632. Via valve 634 the measured and thereby monitored crude sample is discharged or passed on to the CE measuring system. This measuring system is optionally provided with valve 636 for uncoupling the compressor from conduit 192 in order to wholly avoid pressure disturbances. Through the use of optional valve 636 the compressor can even remain on during the measurement. A bypass with valve 638 is optionally provided whereby flushing can take place around the CE chip. Optional pump 640 further discharges liquid.

Additional bypass over the CE chip makes it possible to flush the system around the capillary of the chip. Flushing can hereby take place more quickly. Possibly occurring pressure effects in or on the microchannels of the chip system are also avoided.

Measuring system 600 was tested. The effect of calibration on the measurement accuracy was first investigated here. The results obtained (FIG. 10) make it clear that for the quality of the calibration, and so the accuracy of the measurement, it makes a great difference whether a concentrated sample is diluted and whether or not control takes place on the basis of conductivity as measured on the crude sample. When control takes place on the basis of a fixed value of conductivity of the sample after dilution (taking account of the conductivity of the crude sample—with ions), a neat straight calibration line is obtained for bicarbonate (NCO₃⁻. The same result is obtained for phosphate (not shown). When this does not happen (not taking account of the conductivity of the crude sample—without ions), it is not possible to point to any clear zone displaying linearity. This demonstrates that the dynamic range in which linearity is guaranteed can be considerably increased when crude sample is measured for conductivity and an attempt is made during dynamic dilution to obtain a fixed end value of conductivity.

For a good series it is important that the differences in ionic strength and/or the associated measured conductivity are taken into account. By making the conductivity the same for each sample the linearity of the calibration increases enormously (linear fit produces correlation coefficient of X² of 0.993).

The effect of insulation was also tested in an experiment by performing measurements using different insulating liquids. The results are shown in the table below.

TABLE 1
Insulation with different liquids

| Type of insulating liquid | Electrical conductivity [μS/cm] |
|---|---|
| 100% MilliQ | 1 |
| 90% MilliQ with 10% mains water | 61 |
| 80% MilliQ with 20% mains water | 128 |
| 60% MilliQ with 40% mains water | 252 |
| 100% mains water | 600 |
| 100% demineralized water | 4 |

The results (FIGS. 11A-F) showed that the measurements with 100% milliQ, 100% demineralized water and 90% milliQ with 10% mains water are practically the same, except for a small shift in time. The other three graphs in which the conductivity of the insulating liquid was greater are less good or even unusable.

Observed at a greater value of the conductivity of the insulating liquid was that the leakage currents become dominant relative to the desired current through the chip. The leakage currents are the undesirable currents via the liquid conduits and the manifold with closing valves.

These leakage currents disrupt the desired separation in the CE chip. It is assumed that it is due to these leakage currents that the desired potentials close to the chip do not correspond to the set value.

It can therefore be concluded from the test that insulation is relevant in obtaining reliable measurements.

The present invention is by no means limited to the above described preferred embodiments thereof. The rights sought are defined by the following claims, within the scope of which many modifications can be envisaged. Combinations of the stated measures are particularly possible.

1. Measuring system for measuring an ion concentration in a process liquid using capillary electrophoresis, comprising:
an inlet connectable to a process for supplying the process liquid;
a throughflow system connected to the inlet;
a capillary electrophoresis measuring device connected to the throughflow system and provided with a detector and measuring capillary; and
a data processing unit connected operatively during use to the capillary electrophoresis measuring device.

2. Measuring system as claimed in claim 1, wherein the throughflow system comprises:
a valve for admitting a quantity of process liquid as sample;
a filter for filtering process liquid;
a flushing reservoir for flushing purposes;
a diluting reservoir for diluting a sample; and
switching means for switching valves in the system.

3. Measuring system as claimed in claim 1, wherein the throughflow system is provided with a sample improvement module.

4. Measuring system as claimed in claim 3, wherein the sample improvement module is connected operatively to an internal controller for the purpose of adjusting settings of the module.

5. Measuring system as claimed in claim 1, wherein a voltage source is provided, the voltage source being suitable for applying 2-10 kV over the capillary.

6. Measuring system as claimed in claim 1, wherein the throughflow system is provided with a bypass for bypassing the capillary.

7. Measuring system as claimed in claim 1, wherein an insulating liquid is provided during use such that at least some of the valves are substantially insulated from a voltage during the capillary electrophoresis measurement.

8. Measuring system as claimed in claim 7, wherein feed conduits to the measuring device are provided with the insulating liquid during a measurement.

9. Measuring system as claimed in claim 1, wherein the capillary channel has a length in the range of 2 to 20 cm.

10. Measuring system as claimed in claim 1, wherein the detector of the capillary electrophoresis measuring device has a detector range of about 25-750 μm.

11. Measuring system as claimed in claim 10, wherein the detector is a contactless conductivity detector.

12. Measuring system as claimed in claim 1, wherein more than one chip provided with a separate measuring capillary is provided.

13. Method for online measurement of an ion concentration in a process liquid, comprising:
drawing off a quantity of process liquid;
preparing a measuring system as claimed in claim 1;
preprocessing and transporting a sample from the process liquid to a measuring capillary;
measuring the sample in the measuring capillary with a detector; and
processing the measurement data.

14. Method as claimed in claim 13, further comprising transmitting the processed measurement data to a control system for the process.

15. Method as claimed in claim 13, further comprising automated improvement of a sample with a sample improvement module.

16. Method as claimed in claim 13, wherein the measuring system provides a direct voltage over the capillary in the range of 2 to 10 kV, and preferably about 8 kV.

17. Measuring system as claimed in claim 5, wherein the voltage source being suitable for applying about 8 kV over the capillary.

18. Measuring system as claimed in claim 9, wherein the capillary channel has a length of about 5 cm.

19. Measuring system as claimed in claim 10, wherein the detector of the capillary electrophoresis measuring device has a detector range of about 50-500 μm.

20. Method as claimed in claim 16, wherein the measuring system provides a direct voltage over the capillary of about 8 kV.
